(19) United States
(12) Patent Application Publication
(10) Pub. No.: US 2026/0052225 A1
(43) Pub. Date: Feb. 19, 2026

(54) AUTOMATED DISPUTE DELIVERY SYSTEM

(71) Applicant: Zumedia Inc., New York, NY (US)

(72) Inventors: Phyllis Jager, New York, NY (US); Barry Terach, Goshen, NY (US); Mark Cuban, Dallas, TX (US); Jason Berlin, Campbell Hall, NY (US); Daniel Terach, Monroe, NY (US); Mark Wegener, New York, NY (US)

(21) Appl. No.: 19/369,151

(22) Filed: Oct. 24, 2025

Related U.S. Application Data
(63) Continuation-in-part of application No. 19/364,761, filed on Oct. 21, 2025.
(63) Continuation-in-part of application No. 19/286,121, filed on Jul. 30, 2025.
(63) Continuation-in-part of application No. 18/658,972, filed on May 8, 2024, now abandoned.

(51) Int. Cl. H04N 7/15

(52) U.S. Cl. CPC H04N 7/155

(57) ABSTRACT

A system for disputes comprises a network of servers and one or more computer processors configured to track, collect, and update real-time data associated with users to enable a platform wherein users are dynamically and automatically graded and categorized, based on dispute characteristics and dynamically-adjusted user characteristic values, to enable the settlement of disputes. The system can comprise one or more communicatively coupled servers; one or more users instances, wherein each of the user instances has a unique identifier and associated one or more characteristic values stored in one or more memory devices each having at least one database communicatively coupled to the servers and processors; a communicatively linked processor can adjust the characteristic values associated with each of the user instances to reflect changes in the characteristic values; and the processors can automatically combine users into one or more dispute instances to participate in or view a dispute.

### RELATED APPLICATIONS

This application is a continuation-in-part of pending U.S. application Ser. No. 19/364,761, filed Oct. 21, 2025, entitled “Automated Dispute Delivery System,” which is a continuation-in-part of U.S. application Ser. No. 19/286,121, filed Jul. 30, 2025, entitled, “Automated Dispute Delivery System,” which is a continuation-in-part of U.S. application Ser. No. 18/658,972, filed May 8, 2024, entitled “Automated Dispute Delivery System,” the entireties of which are incorporated herein by reference.

### FIELD OF THE DISCLOSURE

The present disclosure discloses exemplary embodiments of systems and methods for providing a system and platform on which users can dispute with each other, and more particularly, to exemplary embodiments of systems and methods for providing subjects with unique identifiers and associated dynamic characteristic values that structure and provide a forum for disputes.

### BACKGROUND

Many people love to argue. Many do not but find it necessary or desirable. Whether for fun or to settle a dispute, one-against-one, many-against-many, and other interactions have been a part of human organization for at least as long as we have recorded history. In recent years, online systems and methods have been developed that allow social arrangements that provide one-against-one, one-against-many, and many-against-many interactions. However, the present systems and methods do not provide robust dispute resolution abilities with weighting, handicaps, data collection, utilization, and other useful and technical abilities.

Traditional systems rely on fixed data associated with its users and do not adapt in real time to reflect a user's current traits, behavior, interactions, and contributions across online platforms. This becomes a difficult complication that prevents the efficient organization and functioning of large online social networks. There exists a need for a system that enables the constant and real-time collection and utilization of data to rank users in a social network based on their inputs, actions, and reputation over time. Specifically, there is a need to manage user interaction in a way that allows for real-time computation of user characteristic values to facilitate improved communication frameworks and support more effective engagement in disputes. As a result, embodiments in accordance with the present disclosure provide a network of servers comprising one or more computer processors configured to track, collect, and update real-time data associated with users to enable a platform wherein users are dynamically and automatically graded and categorized based on dispute characteristics and dynamically-adjusted user characteristic values to enable the settlement of disputes or the answering of posed issues.

### SUMMARY

Accordingly, exemplary aspects of the present system and method for collaborative online disputes is provided. Disputes can be quarrels, arguments, or any other type of disagreement, e.g. the best way to clean a pot, is the Goldbach conjecture correct. The system for disputes can comprise one or more user instances for disputes, wherein each of the one or more user instances has a unique identifier and one or more characteristic values that can include a set of trait data and a set of history data all associated with a user, wherein each of the users can have a dispute with other users; one or more memory devices each having at least one database, wherein a first memory device has a first database that stores the unique identifier and one or more of the characteristic values associated with one of the user instances; and a processor that adjusts the characteristic values associated with one of the user instances, wherein the adjustment of the characteristic values of the user instances by the processor are altered based on the unique identifier of each user instance such that different user instances are adjusted differently by the controller based on the same external events. External events can include, e.g., number of disputes participated within, age, gender, monitored behavior characteristics within a dispute, ethnicity, user preferences, and others. Monitored behavior characteristics within a dispute can be types of language used (e.g. aggressive or passive), length of responses (e.g. number of characters used), number of responses within each dispute, number of third-party references used in each dispute, accuracy of facts.

In embodiments, a system for disputes comprises one or more communicatively coupled servers with one or more computer processors and memory devices that store and process dispute information; one or more user instances hosted by a server, wherein each of the one or more user instances has a unique identifier and associated one or more characteristic values, including a set of trait data and a set of history data; the unique identifier and one or more of the characteristic values associated with the user instances are stored in the memory devices each having at least one database communicatively coupled to the servers and processors; one or more communicatively linked processors that adjust the characteristic values associated with each of the user instances to reflect changes in the characteristic values; a communicatively linked processor that automatically receives dispute information in real time and automatically adjusts in real time the characteristic values of a unique identifier associated with each of the user instances based on the dispute information; one or more dispute instances hosted by a server, wherein each of the one or more dispute instances is defined by dispute characteristics, including a duration, a topic, one or more characteristic values, and a difficulty level; a communicatively linked processor that assigns a weight to the one or more characteristic values associated with the user instances, wherein the weight assigned to each of the one or more characteristic values associated with the one or more user instances is determined based on one or more of: collected points, number of wins and losses, total dispute time, and achieved difficulty level of the one or more user instances; the one or more communicatively coupled servers track real-time dispute information associated with the unique identifier of the user instances; and based on the weighted characteristic values and dispute characteristics, the processors automatically combine users into one or more dispute instances where a user identified by a unique identifier participates in or views a dispute, wherein the processors launch the dispute at a predetermined time.

In embodiments, a system for disputes comprises one or more communicatively coupled servers comprising one or more communicatively coupled computer processors and one or more memory devices each having at least one database accessible by the one or more communicatively coupled computer processors; one or more user instances hosted by a server, wherein each of the one or more user instances has a unique identifier and one or more characteristic values, comprising in-system and external data, stored in the one or more memory devices; one or more dispute instances hosted by a server, wherein each of the one or more dispute instances is defined by dispute characteristics; the one or more communicatively coupled computer processors configured to organize a social network by: continuously tracking and collecting in-system and external data associated with the unique identifier of user instances in real time; accessing and adjusting the characteristic values stored in the one or more memory devices in real time to reflect changes in characteristic values based on the in-system and external data collected; assigning a weight to the one or more characteristic values associated with the user instances based on dispute characteristics; determining a ranking of user instances based on dispute characteristics and weighted characteristic values; automatically combining users into one or more dispute instances where a user identified by a unique identifier participates in or views a dispute; and launching the dispute at a predetermined time.

Another aspect of the present system and method comprises enabling access to a central repository that can show past disputes and disputes happening or available to access on one or more computer processors as well as on a plurality of servers communicatively coupled to the one or more computer processors over communications links; processing data representative of one or more of interest topics, experience levels, or age of users and comparing the data for different users; automatically deploying additional servers as said disputes multiply or reach a predetermined number of users based on one or more pre-emptive algorithms including how many dispute instances are running and what anticipated end user demand will be; automatically combining users into a dispute instance where a participant can participate in or view a dispute; and launching the dispute at an agreed upon time.

The system and method can include at least one of providing a central repository master browser system; providing an experience calibrated match-making service; providing a dynamic multiuser server component auto deployment and aggregation system; providing a lobby centric simultaneous and collaborative user dispute launching feature; and providing a dispute screen over-layer technology giving users access to a control interface while inside a dispute taking place.

Users can vote on a participant who produces the most compelling argument. Voting can continue on after the dispute ends. A leaderboard can list the participants in order of the number of votes they receive. The leading vote getter at the end of the dispute would be considered the “winner” but as users view the dispute after it has completed and cast votes and those who have voted previously can change their vote at a later date no definitive winner must be determined. The vote tabulation can continue in real time as votes are received. Typically, no one may vote more than once.

Still other aspects, features, and advantages of the present invention are readily apparent from the following detailed description, simply by illustrating a number of exemplary embodiments and implementations for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

FIG. 1 is an example of a network that connects visitors to servers.

FIG. 2 is an example of a server that can be used with the technology disclosed herein.

FIG. 3 is an example of a device that can be used with the technology disclosed herein.

FIG. 4 is an example of how to provide a platform for users to dispute topics as disclosed herein.

FIG. 5 is an example of how a host can design a dispute.

FIG. 6 is an diagram of an embodiment of a dispute recording system.

### DETAILED DESCRIPTION OF EXEMPLARY EMBODIMENTS OF DISCLOSURE

Subject matter will be described more fully herein with reference to the accompanying drawings, which form a part hereof, and which show, by way of illustration, specific example embodiments. This description is not intended as an extensive or detailed discussion of known concepts. Details that are known generally to those of ordinary skill in the relevant art may have been omitted or may be handled in summary fashion.

The following subject matter can be embodied in a variety of different forms, such as methods, devices, components, or systems. Accordingly, this subject matter is not intended to be construed as limited to any example embodiments set forth herein. Rather, example embodiments are provided merely to be illustrative. Such embodiments can, e.g., take the form of hardware, software, firmware, or any combination thereof.

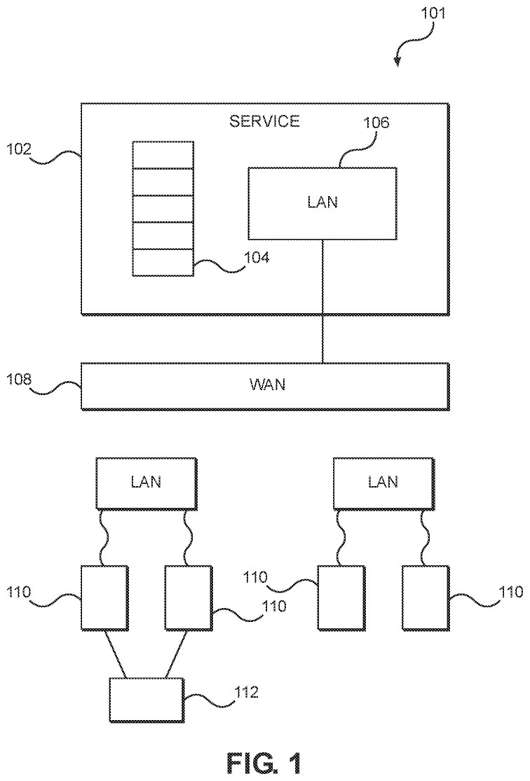

FIG. 1 is an interaction diagram of an embodiment 101 illustrating a service 102 provided by a set of servers 104 to a set of client devices 110 via various types of networks. The servers 104 or client devices 110 can be capable of transmitting, receiving, processing, or storing many types of signals, such as in memory as physical memory states.

The servers 104 of the service 102 can be internally connected via a local area network 106 (LAN), e.g. a wired network where network adapters on the respective servers 104 are interconnected via cables (e.g., coaxial or fiber optic cabling), and can be connected in various topologies (e.g., buses, token rings, meshes, or trees), or a wireless network, e.g. satellite, Wi-Fi, Bluetooth. The servers 104 can be interconnected directly, or through one or more other networking devices, such as routers, switches, or repeaters. The servers 104 can utilize a variety of physical networking protocols (e.g., Ethernet or Fiber Channel) or logical networking protocols (e.g., variants of an Internet Protocol (IP), a Transmission Control Protocol (TCP), or a User Datagram Protocol (UDP). The local area network 106 can include, e.g., analog telephone lines, such as a twisted wire pair, a coaxial cable, full or fractional digital lines including T1, T2, T3, or T4 type lines, Integrated Services Digital Networks (ISDNs), Digital Subscriber Lines (DSLs), wireless links including satellite links, or other communication links or channels, such as may be known to those skilled in the art. The local area network 106 can be organized according to one or more network architectures, such as server/client, peer-to-peer, or mesh architectures, or a variety of roles, such as administrative servers, authentication servers, security monitor servers, data stores for objects such as files and databases, business logic servers, time synchronization servers, or front-end servers providing a user/visitor-facing interface for the service 102.

The local area network 106 can comprise one or more sub-networks, such as can employ differing architectures, can be compliant or compatible with differing protocols or can interoperate within the local area network 106. Additionally, a variety of local area networks 106 can be interconnected, e.g., a router can provide a link between otherwise separate and independent local area networks 106.

As shown in FIG. 1, the local area network 106 of the service 102 is connected to a wide area network 108 (WAN) that allows the service 102 to exchange data with other services 102 or client devices 110. The wide area network 108 can encompass various combinations of devices with varying levels of distribution and exposure, such as a public wide-area network (e.g., the Internet) or a private network (e.g., a virtual private network (VPN) of a distributed enterprise).

As shown in FIG. 1, shows an embodiment of the system 101, where the service 102 can be accessed via the wide area network 108 by a user 112 of one or more client devices 110, such as a desktop computer, portable media player (e.g., a portable gaming device); a portable communication device (e.g., a camera, a phone, a wearable device, an implantable device, or a text chatting device); a virtual reality device, a workstation; or a laptop form factor computer. The respective client devices 110 can communicate with the service 102 via various connections to the wide area network 108. As a first example, one or more client devices 110 can comprise a cellular communicator and can communicate with the service 102 by connecting to the wide area network 108 via a wireless local area network 106 provided by a cellular provider. As a second such example, one or more client devices 110 can communicate with the service 102 by connecting to the wide area network 108 via a wireless local area network 106 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the servers 104 and the client devices 110 can communicate over various types of networks. Other types of networks that can be accessed by the servers 104 or client devices 110 include mass storage, such as network attached storage (NAS), a storage area network (SAN), or other forms of computer or machine-readable media.

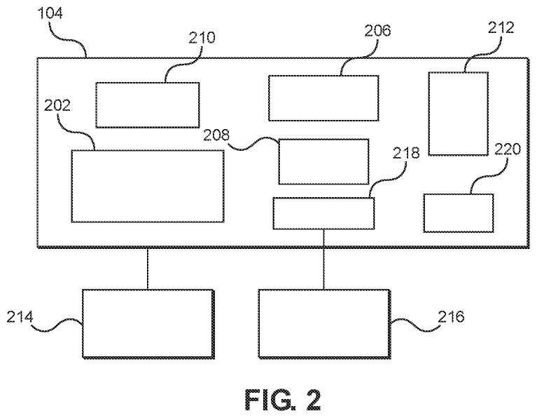

FIG. 2 is a schematic architecture diagram 200 of an example of a server 104 that can utilize at least a portion of the services or processes provided herein. Such a server 104 can vary widely in configuration or capabilities, alone or in conjunction with other servers, in order to provide a service such as the service 102.

The server 104 can comprise one or more processors 210 that process instructions and coordinate the functionality of the system. The one or more processors 210 can optionally include a plurality of cores; one or more coprocessors, such as a mathematics coprocessor or an integrated graphical processing unit (GPU); or one or more layers of local cache memory. The server 104 can comprise memory 202 accessible by one or more processors 210 and configured to store various forms of applications, such as an operating system 204; one or more server applications 206, such as a hypertext transport protocol (HTTP) server, a file transfer protocol (FTP) server, or a simple mail transport protocol (SMTP) server; or various forms of data, such as a database 208 or a file system. The server 104 can comprise a variety of peripheral components, such as a wired or wireless network adapter 214 connectible to a local area network or wide area network; one or more storage components 216, such as a hard disk drive, a solid-state storage device (SSD), a flash memory device, or a magnetic or optical disk reader.

The server 104 can comprise a mainboard featuring one or more communication buses 212 that interconnect the processor 210, the memory 202, and various peripherals, using a variety of bus technologies, such as a variant of a serial or parallel AT Attachment (ATA) bus protocol; a Uniform Serial Bus (USB) protocol; or Small Computer System Interface (SCI) bus protocol. In a multibus embodiment, a communication bus 212 can interconnect the server 104 with at least one other server. Other components that can optionally be included with the server 104 (though not shown in the schematic architecture diagram 200 of FIG. 2) include a display; a display adapter, such as a graphical processing unit (GPU); input peripherals, such as a keyboard or mouse; and a flash memory device that can store a basic input/output system (BIOS) routine that facilitates booting the server 104 to a state of readiness.

The server 104 can operate in various physical enclosures. The server 104 can be mounted horizontally or in a cabinet or rack, or can simply comprise an interconnected set of components. The server 104 can comprise a dedicated or shared power supply 218 that supplies or regulates power for the other components. The server 104 can provide power to or receive power from another server or other devices. The server 104 can comprise a shared or dedicated climate control unit 220 that regulates climate properties, such as temperature, humidity, or airflow. Many such servers 104 can be configured or adapted to utilize at least a portion of the techniques presented herein.

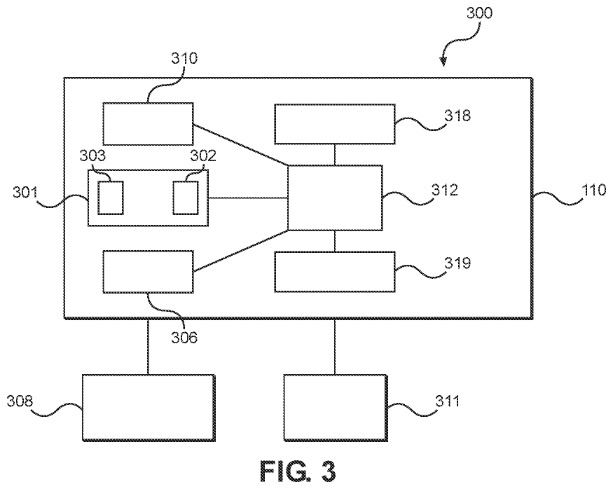

FIG. 3 presents a schematic architecture diagram 300 of an example of a client device 110 whereupon at least a portion of the techniques presented herein can be implemented. Such a client device 110 can vary widely in configuration or capabilities, in order to provide a variety of functionality to a user such as the visitor 112. The client device 110 can be provided in a variety of form factors, such as a desktop or tower workstation; an “all-in-one” device integrated with a display 308; a laptop, tablet, convertible tablet, or palmtop device; a wearable device mountable in a headset, eyeglass, earpiece, or wristwatch, an implantable device, any of these devices integrated with an article of clothing; or a component of a piece of furniture, such as a tabletop, or of another device, such as a vehicle or residence. The client device 110 can serve the user in a variety of roles, such as a workstation, kiosk, media player, gaming device, or appliance.

The client device 110 can comprise one or more processors 310 that process instructions. The one or more processors 310 can optionally include a plurality of cores; one or more coprocessors, such as a mathematics coprocessor or an integrated graphical processing unit (GPU); or one or more layers of local cache memory. The client device 110 can comprise memory 301 storing various forms of applications, such as an operating system 303; one or more user applications 302, such as document applications, media applications, file or data access applications, communication applications such as web browsers or email clients, utilities, or games; or drivers for various peripherals. The client device 110 can comprise a variety of peripheral components, such as a wired or wireless network adapter 306 connectible to a local area network or wide area network; one or more output components, such as a display 308 coupled with a display adapter (optionally including a graphical processing unit (GPU)), a sound adapter coupled with a speaker, or a printer; input devices for receiving input from the user, such as a keyboard 311, a mouse, a microphone, a camera, or a touch-sensitive component of the display 308; or environmental sensors, such as a global positioning system (GPS) receiver 319 that detects the location, velocity, or acceleration of the client device 110, a compass, accelerometer, or gyroscope that detects a physical orientation of the client device 110. Other components that can optionally be included with the client device 110 (though not shown in the schematic architecture diagram 300 of FIG. 3) include one or more storage components, such as a hard disk drive, a solid-state storage device (SSD), a flash memory device, or a magnetic or optical disk reader; or a flash memory device that can store a basic input/output system (BIOS) routine that facilitates booting the client device 110 to a state of readiness; and a climate control unit that regulates climate properties, such as temperature, humidity, and airflow.

The client device 110 can comprise a mainboard featuring one or more communication buses 312 that interconnect the processor 310, the memory 301, and various peripherals, using a variety of bus technologies, such as a variant of a serial or parallel AT Attachment (ATA) bus protocol; the Uniform Serial Bus (USB) protocol; or the Small Computer System Interface (SCI) bus protocol. The client device 110 can comprise a dedicated or shared power supply 318 that supplies or regulates power for other components, or a battery 304 that stores power for use while the client device 110 is not connected to a power source via the power supply 318. The client device 110 can provide power to or receive power from other client devices.

In some embodiments, as a user 112 interacts with a software application on a client device 110 (e.g., social media platform or electronic mail application), descriptive content in the form of signals or stored physical states within memory (e.g., an email address, instant messenger identifier, phone number, postal address, message content, date, or time) can be identified. Descriptive content can be stored, typically along with contextual content, e.g., the source of a phone number (e.g., a communication received from another user via an instant messenger application) that can be stored as contextual content associated with the phone number. Contextual content, therefore, can identify circumstances surrounding receipt of a phone number (e.g., the date or time that the phone number was received), and can be associated with descriptive content. Contextual content can be used to subsequently search for associated descriptive content, e.g. a search for phone numbers received from specific individuals, received via an instant messenger application or at a given date or time, can be initiated. The client device 110 can include one or more servers that can locally serve the client device 110 or other client devices of the user 112 or other individuals, e.g., a locally installed webserver can provide web content in response to locally submitted web requests. Many such client devices 110 can be configured or adapted to utilize at least a portion of the techniques presented herein.

In another embodiment a user 112 can interact with a remote server through a communication channel using a client device 110. The user's interaction with remote server provides for descriptive content in the form of signals or stored physical states within memory (e.g., an email address, instant messenger identifier, phone number, postal address, message content, date, or time) that can be identified. Descriptive content can be stored, typically along with contextual content, e.g., the source of a phone number (e.g., a communication received from another user via an instant messenger application) that can be stored as contextual content associated with the phone number. Contextual content, therefore, can identify circumstances surrounding receipt of a phone number (e.g., the date or time that the phone number was received), and can be associated with descriptive content. Contextual content can be used to subsequently search for associated descriptive content, e.g. a search for phone numbers received from specific individuals, received via an instant messenger application or at a given date or time, can be initiated. The client device 110 can include one or more servers that can locally serve the client device 110 or other client devices of the user 112 or other individuals, e.g., a locally installed webserver can provide web content in response to locally submitted web requests. Many such client devices 110 can be configured or adapted to utilize at least a portion of the techniques presented herein.

One or more computing devices or techniques for providing a dispute system are provided. A system provider can provide users with dispute related content through user interfaces, such as a webpage provided through a web browser.

The system for disputes can comprise one or more users instances for disputes, wherein each of the one or more user instances has a unique identifier and associated one or more characteristic values. The user instances can be a host, moderator, participant, or spectator, and are generically named “user” herein. A user can be a person, persons, or an artificial intelligence, i.e. software used for decision making and problem solving, based on data, reasoning, or inferences. The system can create a stream of data associated with a user, that can include audio and visual data, of the user's participation in a dispute. As used herein, a “characteristic value” refers to a specific value assigned by one or more processor(s) of the system to a particular attribute associated with a unique identifier. Characteristic values can be expressed in various formats, including but not limited to numerical and non-numerical. In embodiments, non-numerical characteristic values can be mapped to numerical equivalents to facilitate comparison, scoring, and weighting operations of the system described herein. Characteristic values can include in-system and external data, including a set of trait data and a set of history data. The trait data characteristic values can include demographic and personal attributes (e.g., gender, race, religion, age, sex, physical or mental abilities, expertise, education, or others). The history data can include metrics related to a user's interaction and engagement (or inaction) with the system (e.g., past dispute success, number of disputes participated, or length of time as a user on the system). In certain embodiments, the characteristic values can further incorporate user-related data collected from user profiles on external platforms (e.g., social media platforms, online forums, e-commerce sites) and other external events that occur separate from the system. For example, data can include information aggregated from user profiles on other social media platforms, including, for example, profile information (e.g., location, account creation date, verified status), content information (e.g., text posts, images and videos, tags), engagement data (e.g., number of followers, likes, views, shares), and behavior data (e.g., post frequency, topics of interest, affiliations).

Each user instance has a unique identifier that is associated with one or more characteristic values including, at least, a set of trait data and a set of history data. The system can comprise a network of processors configured to continuously track, collect, and update real-time data associated with unique identifiers of user instances. Data can be obtained by the system from, for example, user input, user interaction and engagement with the system, and external online platforms. The unique identifier and one or more of the characteristic values associated with one of the user instances is stored in one or more memory devices each having at least one database. A processor communicatively linked to the memory devices can access the one or more memory devices to upload any adjustments to the characteristic values associated with each of the user instances to reflect changes in characteristic values in real time. Certain characteristic values can continuously change due to changes in trait data or history data, e.g. aging, expertise, dispute success, gained expertise, or other external user-related data aggregated by the system. Utilizing dynamic characteristic values that reflect continuously changing user-related data enables the system to improve the accuracy and relevance of dispute participant selection. The method for online disputes can comprise enabling access to a central repository that shows disputes currently running or available to run on one or more computer processors as well as on a plurality of servers communicatively coupled to the one or more computer processors over communications links. This can be a database of past disputes providing, e.g., their topic, outcome, participants, spectators, a summary; a database of currently open and on-going disputes, e.g., topic, participants, spectators; a database of planned future disputes, e.g., dates and times, topics.

The processor(s) processes data for unique identifiers representative of one or more characteristic values and associates unique identifiers with potential disputes available to access. One or more processors, in communication with one or more memory devices, can be configured to access a set of dynamically-updated characteristic values associated with unique identifiers stored in the memory devices, and, based upon the characteristics of a potential dispute (e.g., duration, title, topic, designated characteristics of users based on characteristic values, difficulty level), can identify unique identifiers determined to be relevant to potential disputes available for access or participation. The processor(s) can automatically combine users into one or more dispute instances where a user identified by a unique identifier can participate in or view a dispute. The processor(s) can launch the dispute at an agreed upon time.

The system can automatically deploy additional servers as said disputes multiply or reach a predetermined number of users based on one or more pre-emptive algorithms including how many dispute instances are running and anticipated user demand.

The system can also be adapted to support online tournament style disputes that can include, identifying qualified users, ranking or seeding users, bracketing or matching each round, scheduling disputes, resolving disputes, broadcasting the tournament, results verification, and timely communication of tournament data. The system can comprise a network of servers that track real-time dispute data associated with a plurality of unique identifiers, a tournament server that receives a request for a tournament, wherein the request further specifies one or more parameters for one or more of the disputes, the parameters including one or more seeding qualifications for one or more brackets of the tournament, ranks the unique identifiers based on the dispute data that meets the seeding qualifications of the specified parameters for the specified disputes, identifies a set of the unique identifiers as qualified to be seeded for the tournament based on the ranking, seeds each of the qualified unique identifiers to a corresponding match within one of the brackets of the tournament based on the ranking, generates a stream for the corresponding match in the bracket, wherein the stream is associated with the unique identifiers assigned to the corresponding match, and distributes the generated stream to one or more user devices over a communication network.

“Real time” means contemporaneously or near contemporaneously such that a human observer can detect little to no delay between measurement and display. Since the online system 101 is in communication with the network and servers, the online system 101 can receive and analyze dispute data in real-time. As such, online system 101 can detect when a dispute has started, when the dispute is particularly active or competitive, the number of users in a dispute, the number of shares of a dispute, the number of “likes” or “dislikes” of a dispute, and other in-dispute events. This data enables a traction indicator that can be posted and shared on the platform and shared outside the platform.

The data stream of users' disputes can be recorded for playback. Different embodiments allow for different recording options as written herein. Whether to record can be an option of a host or another user or it can be applied to all disputes by the platform. The recordings can be stored in a system server. Access to the recorded disputes can be assigned to certain users or all users by the platform, host, or other user. Users can opt in or out of recordings. A fee can be applied to opting in or out. In some embodiments, recordings can be accessed during a dispute for reasons such as fact checking or recollection of questions or statements.

Screenshots or video of a dispute may be captured and published with links that can take a user to the stream, whether at the beginning of the dispute or directly to a point of interest. Such links may be accessed in real-time (e.g., as the dispute is occurring) or in association with an archived stream. In some embodiments, such links may be published on the dispute system (e.g., landing pages, leaderboards, communities, forums, user profiles, team profiles, tournament profiles, bookmarks) or on sites associated with the user.

The request received by the server can be made by a server processor or by input from a user. The parameters can include one or more seeding qualifications, topic preferences, or characteristic values. Each tournament can be bracketed by the tournament server with each dispute within a bracket played one against one, one against many, or many against many.

Team disputes and tournaments can be set up in various ways, e.g., teams can be comprised of 8 members of similar skill level. There can be a team captain designated or automatically assigned. Teams can compete in individual disputes as well as tournaments and leagues. “Winners” of team disputes can be the teams that received the most votes combined of all members of the team as of the end of the dispute. Voting can continue from viewers of recorded team disputes but may not change the outcome.

In certain embodiments, users that progress through the registration process 402 can obtain badges, e.g., a red badge is achieved when the user initially opens an account and verifies email and mobile phone number via OTP code. The red badge can give a user limited access to join a dispute but not host a dispute. The red badge can allow a user to be a spectator but cannot text comment. But, a red badge does not permit earning revenue or receive tips or gifts. Another option can be that a red badge holder cannot join or captain a team or red badge holders cannot appear on leaderboards. another option can be red badge holders cannot opt into underlayment rental.

In some embodiments, e.g., a yellow badge can be achieved by activating 2FA authentication and providing a facial recognition or retinal scan to the system and platform. A yellow badge can allow for joining, moderating, or hosting a dispute, and to join as a spectator. In some embodiments, yellow badge holders cannot text or comment in the platform. In some embodiments yellow badge holders cannot earn revenue or receive gifts or tips. In some embodiments yellow badge holders cannot captain or join teams. In some embodiments yellow badge holders cannot opt into underlayment rental.

In some embodiments, a green badge can be achieved by a user providing ID authentication through a third-party verification service plug in (e.g. au10tix) or by providing a verified social media account (an account where the user's identity was previously vetted) and featured in a video, or article, or news story. In some embodiments, green badge holders can have full access to all services, e.g. green badge holders can earn revenue and receive gifts and tips. In some embodiments green badge holders can opt-in to underlayment rental. In some embodiments, green badge holders can join and captain teams. In some embodiments, green badge holders can join, host, or moderate disputes. In some embodiments, green badge holders can text, comment, and use a unique user name. In some embodiments green badge holders can appear on leaderboards.

In some embodiments a blue badge can be reserved for public figures who have an established on-line presence. In some embodiments to obtain a blue badge a user must submit a four live links to articles, videos, or news stories or three live links and one already verified social media account. In some embodiments blue badge holders enjoy the same benefits as the green badge holders with the blue badge having the distinction of the user being a notable figure.

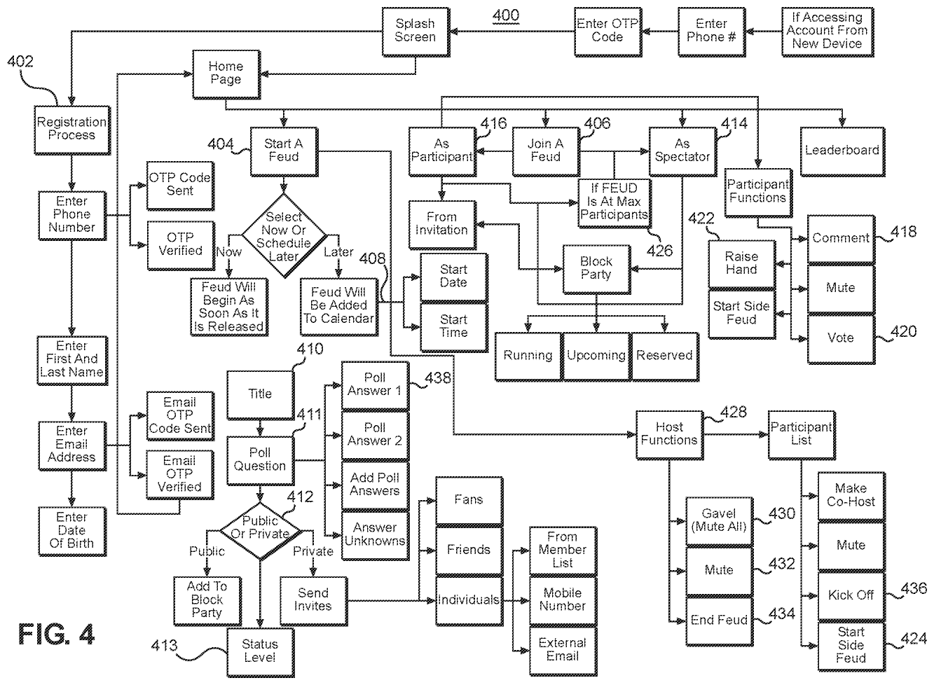

FIG. 4 is an example of an embodiment of the technology. A first time user can register 402 to a platform hosting an instance of an automated dispute delivery system 400. A registered user can login to the system 400 using a predetermined password, biometric recognition, or other security measure.

Once logged into the system, a user can design a dispute 404 or join an already defined dispute 406. A dispute can be a specific instance on a server of a data stream into which users can join and communicate, creating, and combining with others, data streams. Each dispute can be defined by predetermined characteristics including scheduled time 408, length, dispute topic 410, poll questions 411, whether it will be public or private 412, status level 413, and others. Poll questions 411 can be different levels of difficulty. This can help filter participants, i.e. difficult poll questions will lead to more participants experienced in that topic.

A user that joins a dispute can join as a spectator 414 or participant 416. A spectator can be granted certain limited rights during the dispute that can include vote 420, comment 418, but that do not include inserting argument. A participant can insert argument, comment 418, vote 420, raise hand 422, and other options. A participant can be more than one user. A side dispute 424 can also be started by a user. The number of participants or spectators might be limited 426 from one (no spectators, there must be at least 1 participant) to the maximum amount capable of being hosted on the servers. Upon reaching an amount of users dynamically determined by the processors based on capacity, bandwidth, and speed of delivery of content, the system can automatically deploy additional servers.

A user can also be a host or co-host. Hosts can 428 mute all users 430 in a dispute, mute individual users in a dispute 432, end a dispute 434, eject another user 436, start and stop a dispute 404, 434, and start a side dispute 424.

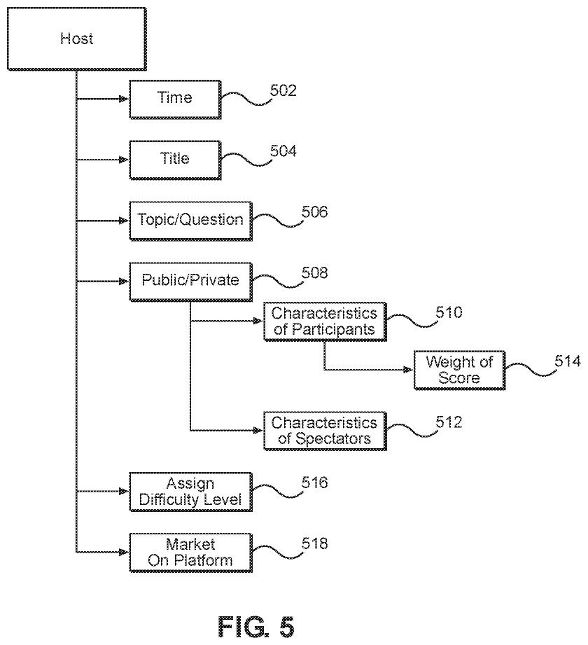

FIG. 5 is an example of how a host can design a dispute. The host can be an artificial intelligence or a human user. A user can login as a host on the system. The design features from which a host can choose comprise schedule a dispute for a specific time or duration 502, e.g. as soon as it is organized or at a future time and date; a dispute title 504, e.g. The Best Way to Clean a Rug; a dispute topic 506, e.g. poll questions, summary, outline; designating public or private 508; further designating characteristics of participants 510 and spectators 512 based on characteristic values 514, e.g. weighted score, experience level, age; assign a difficulty level 516; market the dispute on the system or outside of the system 518, e.g. pay to post banners on the system, pay for the system to market dispute on the Internet. A host can be a person or an artificial intelligence created to pick the characteristics of a dispute based on predetermined criteria, e.g. most subscribed to topics, topics with most divergent positions, obscurity of topic, ranking of users, most preferred timing. Poll questions 438 can be used to create opposing sides of a dispute. There can be two or more opposing sides in a dispute. Poll questions 438 can have unknown answers.

A host can also be responsible for moderating the dispute, e.g. facilitate, review, and guide a dispute and related interactions to ensure the content is appropriate and follows system rules. Moderating disputes can also be done by artificial intelligence or another user. A host can monitor participant comments 418 or questions. A host can end a dispute and upload a dispute content onto a viewing platform for future viewing by users. The dispute content can also be saved on a server that acts as an accessible reference encyclopedia or wiki with answers and reasoning from past disputes.

A moderator can also be a user who is contracted by a host to act as a judge who governs a dispute. The moderator's duties can include: enforcing dispute rules set by the host; guiding the dispute so that participants remain on topic (e.g. mute, recognize hand raise, use gavel to quiet entire conversation); discipline unruly participants (kick out, demote to spectator); accept or reject requests to join dispute.

In some embodiments, a host can remove a moderator for different reasons, e.g. not performing duties or remaining impartial by posing a vote to remove to all the participants. In some embodiments the moderator can be removed with a vote of the participants or users, e.g. ⅔ majority of votes of participants to remove.

In some embodiments a moderator can receive a fee or other compensation through the platform for performing the duties. In some embodiments, for a moderator to receive credit for a dispute, the dispute must be completed and have a duration of at least 30 minutes.

A user can opt in to become a moderator, e.g. from the Account Settings Menu select Opt Ins Moderator, Toggle on Moderator, User is added to the Moderator List for Hosts to select.

Moderators experience level can be illustrated by a “Ribbon” displayed over the bottom of their profile picture, e.g.

| | |
|---|---|
| White Ribbon-Novice Moderator | 0-500 disputes moderated |
| Orange Ribbon-Amateur Moderator | 500-1000 disputes moderated |
| Pink Ribbon-Established Moderator | 1000-2000 disputes moderated |
| Purple Ribbon-Pro Moderator | 2000+ disputes Moderated |

In some embodiments moderators can be yellow badge or above but only green and blue badges can earn revenue, e.g. established and pro moderators can charge a fee to moderate a dispute as long as they hold a green or blue badge.

Moderators can be effective for team competitions and debates to have someone impartial to preside over the dispute.

Moderating the dispute can include acknowledging when a participant wants to add a statement or question, muting participants 430, gaveling the dispute by muting all participants 430, or removing one or more participants 436 from the dispute. The host can mute participants 430 when another participant is adding a statement or question.

A participant can participate in a dispute and a spectator can participate in a dispute. A participant can join a dispute after searching a database or receiving an invitation and signing in to the dispute. Participants can use microphones and cameras to participate in a dispute. Participants can also use text or icons (emojis) to participate in a dispute. Participants can also participate in multiple disputes and side disputes at once. Participants can answer poll questions presented by the host, they can vote for liked or disliked positions of other participants, they can add comments or ask questions, they can reply to comments of other users or the host, and they can review the dispute history.

A spectator can participate in a dispute by joining a dispute after searching a database or receiving an invitation and signing into the dispute. The spectator can request of the host to become a participant 920. A spectator can use a camera, microphone, text or emojis. A spectator can comment, vote, and leave reviews, if those design features are provided for the spectator by the host.

Spectator tools may also be provided to enable users to discover, tune in, watch, and interact in relation to a dispute. Discovery may involve providing certain kinds of information (e.g., from player or team profiles) so that a would-be spectator may determine whether a user, team, match, tournament, commentator, or other content producer/streamer may be of interest. A spectator can further subscribe or follow a user, team, game title, or tournament of interest. Such a subscriber may therefore be provided with automatic notifications based on certain events or activities (e.g., scores, lead changes, dispute results, standings after each round, updated brackets) detected on the system as being related to the subject of interest.

In various embodiments, metrics (dispute performance attributes) that can be included in the characteristic values of a unique identifier can be weighted based on various factors, including degree of dispute difficulty, expertise or ranking of the opponent(s), how recent dispute performance was made, and others. One or more processors, in communication with one or more memory devices, can be configured to access characteristic values associated with unique identifiers stored in the memory devices, and, based upon the characteristics of a potential dispute (e.g., duration, title, topic, designated characteristics of users based on characteristic values, difficulty level), can identify unique identifiers determined to be relevant to potential disputes available for access or participation. The processor(s) can determine the appropriate weight to be afforded to the dynamic characteristic values associated with the identified unique identifiers, and apply such weighting to the characteristic values, such that attributes more relevant to the characteristics of a particular dispute are afforded greater weight in determining the relevance or suitability of the user instance to the dispute. Accordingly, adjustments to the weighting applied to the characteristic values can vary from one dispute to another, depending on the identified dispute characteristics. For example, the processor can afford more weight to characteristic values more relevant to the identified dispute topic. This calculation enables the processor(s) to determine a ranking of user instances for participation in or viewing of such potential dispute and automatically combine user instances into one or more dispute instances.

During a qualification period of a tournament, for example, the system may evaluate one or more dispute performance attributes, and statistics to determine a skill level (weight) for each participant. This can be done by a ranking module. Determinations of skill level can vary depending upon the specified dispute performance attributes, and can vary between disputes, or dispute topic categories. By way of example, skill level for a given participant can be based on one or more of: collected points, number of wins/losses, total dispute time, achieved difficulty level, number of positive or negative votes from other participants or spectators, etc. Since disputes occur on the system, one or more processors of the dispute system can continuously monitor ongoing disputes and obtain results automatically and in real time. The one or more processors can access one or more memory devices configured to store the characteristic values associated with user instances participating in the ongoing dispute, and update characteristic values to reflect dispute data and information (e.g., number of votes, collected points, “likes” or “dislikes”, shares) collected by the processor(s), thereby allowing for the dynamic adjustment of characteristic values and metrics generation, evaluation, and use in updating rankings, achievements designations, and leaderboards.

In some embodiments, participants registered for a given dispute or tournament can be ranked into multiple categories or tiers of skill level, e.g., participants may be categorized into a platinum tier for being in the top 2% of players, into a gold tier for being in the next 20% of players, into a silver tier for being in the next 28% of players, and into a bronze tier designated for the last 32%. Such tiers may further be subdivided as needed.

Designations of achievement or skill level can be provided based on the overall ranking of a participant. For example, digital badges, trophies, or medals can be provided to the top-ranked participants, published on the system, and added to a users characteristic values. Such designations may be awarded as to a current season and remain visible in future seasons. Different designations may be provided for different disputes, different combinations of achievements, overall ratings, etc. Such designations and tier levels can serve as the basis for matching participants, and such indicators may be searched by spectators looking to watch participants of a certain level in a certain topic. Various search and sorting options may be provided (e.g., game title, ranking, stream parameters) so that participants or potential spectators may filter through the available game streams, participants, teams, tournaments, etc. to find other participants of interest. A participant may wish to find a similarly-skilled practice sparring partner, for example, or a teammate with complementary skills. Such spectators may choose to follow such participants, for example, and request notifications, reminders, and schedules relating to matches involving the participant(s) of interest. In some embodiments, such designations may be made available through other outlets (e.g., stream sources such as Twitch) for searching and filtering based on a standardized skill evaluation system.

Different ranking systems may be available for different disputes. Moreover, different ranking systems may be available for disputes and tournaments. A dispute or tournament may involve multiple dispute topics, for example, and as such, a ranking system may combine, or weight different individual rankings within the dispute topics as desired by the host. An overall ranking may also be available. As such, a participant may distinguish themselves as a skilled participant not only in one or a few dispute topics, but within multiple different types of dispute topics.

Depending on the number of participants and spectators, a tournament may hold a set of qualifying rounds to reduce the number of registrants to a desired number. Alternatively, the host may elect to have an invitation-based system based on rankings and any other factors deemed appropriate.

The system's automated identification of unusual, interesting, or otherwise significant events may also allow for advertising, promotion, discovery, and related functions. As such, notifications, reminders, video clips, screenshots, and other data can also be generated and provided to other parties and users in real-time regarding such events. Such data can also support commentators and third-party broadcasters/streamers for use in producing their respective content streams. This can be done using an RSS feed that provides current or trending news stories as a plug-in. Users can employ this information as topics or to inform their arguments in a dispute.

Dispute answers or outcomes can be aggregated into a dynamic knowledge repository that functions as a wiki. The knowledge will change and modify as results from disputes change or are refined.

It is understood that the client devices can include various types of processor-based systems, including but not limited to: personal computing devices, smartphones, tablets, other portable gaming devices, and the like. Such client devices may also be configured to access data from other storage media, such as memory cards or disk drives as may be appropriate in the case of downloaded services. Client devices may include standard hardware computing components such as network and media interfaces, non-transitory computer-readable storage (memory), and processors for executing instructions that may be stored in memory.

Users are permitted access to the system via their respective computing systems. Computing systems may include any type of server or other computing device, including standard hardware computing components such as network and media interfaces, non-transitory computer-readable storage (memory), and processors for executing instructions or accessing information that may be stored in memory. The functionalities of multiple servers may be integrated into a single server. Any of the aforementioned servers (or an integrated server) may take on certain client-side, cache, or proxy server characteristics. These characteristics may depend on the particular network placement of the server or certain configurations of the server.

A system for disputes can comprising one or more communicatively coupled servers comprising one or more computer processors and one or more memory devices that store and process dispute information; one or more user instances hosted by the one or more communicatively coupled servers, wherein each of the one or more user instances has a unique identifier and associated one or more characteristic values, including a set of trait data and a set of history data; the unique identifier and the one or more characteristic values associated with the user instances are stored in the one or more memory devices communicatively coupled to the one or more communicatively coupled servers and the one or more computer processors; one or more computer processors that adjust the characteristic values associated with each of the user instances to reflect changes in the characteristic values; one or more computer processors that automatically receive dispute information in real time and automatically adjusts in real time the characteristic values of the unique identifier associated with each of the user instances based on the dispute information; one or more dispute instances hosted by a server, wherein each of the one or more dispute instances is defined by dispute characteristics, including a duration, a topic, one or more characteristic values, and a difficulty level; one or more computer processors that assigns a weight to the one or more characteristic values associated with the user instances, wherein the weight assigned to each of the one or more characteristic values associated with the one or more user instances is determined based on one or more of: collected points, number of wins and losses, total dispute time, and achieved difficulty level of the one or more user instances; one or more computer processors comprise a selective forward unit server that combines user dispute streams of dispute instances; the selective forward unit server feeds real-time user dispute streams associated with the unique identifier of the user instances to a virtual bot that facilitates the streaming and recording of the user dispute streams; a server combines the user dispute streams into a dispute single stream, which is delivered to a real time messaging protocol server; the real time messaging protocol server can deliver the dispute single steam to a storage system that can be accessed by users for playback; and, based on the weighted characteristic values and dispute characteristics, the one or more computer processors automatically combine users into one or more dispute instances where a user identified by a unique identifier participates in or views a dispute, wherein the one or more computer processors launch the dispute at a predetermined time.

A system for disputes can also comprise one or more communicatively coupled servers comprising one or more communicatively coupled computer processors and one or more memory devices each having at least one database accessible by the one or more communicatively coupled computer processors; one or more user instances hosted by a server, wherein each of the one or more user instances has a unique identifier and one or more characteristic values, comprising in-system and external data, stored in the one or more memory devices; one or more dispute instances hosted by a selective forward unit server, wherein each of the one or more dispute instances is defined by dispute characteristics; the one or more communicatively coupled computer processors can be configured to organize a social network by: continuously tracking and collecting in-system and external data associated with the unique identifier of user instances in real time; accessing and adjusting the characteristic values stored in the one or more memory devices in real time to reflect changes in characteristic values based on the in-system and external data collected; assigning a weight to the one or more characteristic values associated with the user instances based on the dispute characteristics; determining a ranking of user instances based on the dispute characteristics and the weighted characteristic values; automatically combining users into one or more dispute instances where a user identified by a unique identifier participates in or views a dispute; launching the dispute at a predetermined time; and recording the dispute using a virtual bot that routes the user dispute streams to a streaming server that combines the user dispute streams into a single dispute stream and delivers the dispute stream to a storage system for playback.

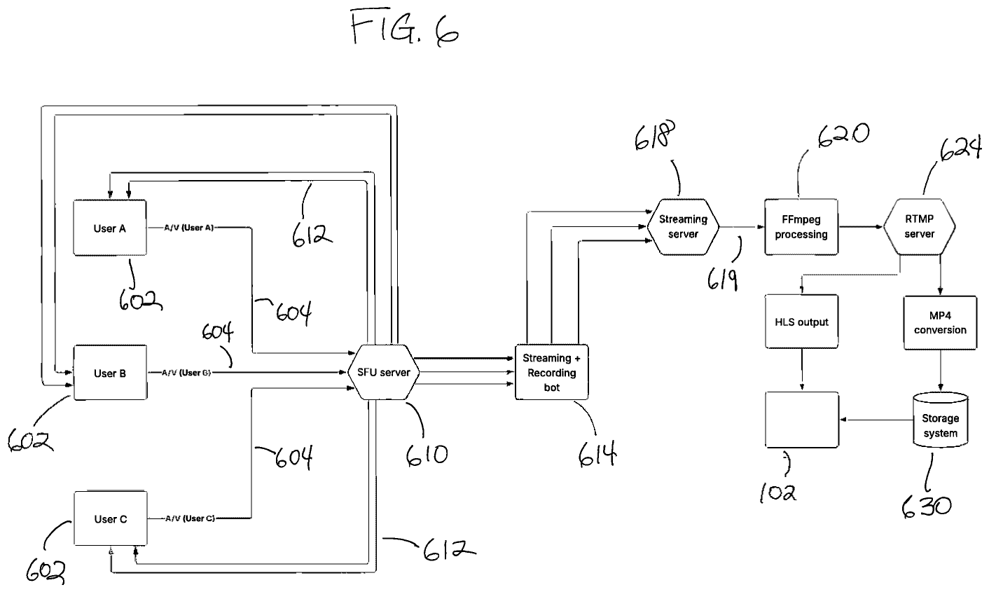

FIG. 6 is a diagram demonstrating one embodiment of a data stream recording process that allows for simultaneous live streaming and recording of multiparty virtual disputes. When a user 602 initiates a dispute, a virtual room is created to host the data streams of a dispute and the other users. Audio and video signals that are streamed during the dispute can be routed 604 through the SFU 610 (Selective Forwarding Unit) server. The SFU server 610 can forward the audio and video signal streams 612 to other users 602 within the dispute, allowing users to hear, see, and communicate with other users in real time.

The SFU server 610 can also send users audio and video signals to a virtual bot 614 that is responsible for facilitating the streaming and recording of the dispute. A virtual bot is a software program designed to automate tasks and simulate human interaction. The virtual bot 614 can use artificial intelligence to understand and respond to queries made by users 602. The virtual bot 614 processes the audio and video signals of each user in the dispute instance. FFmpeg commands or other software 620 can be used to capture and encode the incoming audio and video signals.

The audio and video signals can be combined into a single stream 619 and delivered by a streaming server 618 to a RTMP (Real Time Messaging Protocol) server 624. The stream can be routed from the RTMP 624 server to the dispute service 102 via an HLS protocol, allowing users to join and participate in a live dispute. Simultaneously, an instance of the processed multimedia stream 619 can be remixed from FLV (flash video) to MP4 format and delivered to a storage system 630. The MP4 files are saved in the storage system 630 and sent to the service 102, allowing users to watch and interact with the recorded dispute.

This process enables users on the service 102 to watch current live disputes, join live disputes to participate in real time, and watch past recorded disputes while still maintaining the ability to interact with components of the dispute (such as submitting a vote or reading and writing comments). The result is a seamless experience for the user, allowing them to interact with disputes regardless of when they occur.

As used in this application, “component,” “module,” “system”, “interface”, or the like are generally intended to refer to a computer-related entity, either hardware, a combination of hardware and software, software, or software in execution, e.g., a component can be, but is not limited to being, a process running on a processor, a processor, an object, an executable, a thread of execution, a program, or a computer. By way of illustration, both an application running on a controller and the controller can be a component. One or more components can reside within a process or thread of execution and a component can be localized on one computer or distributed between two or more computers.

Unless specified otherwise, “first,” “second,” or the like are not intended to imply a temporal aspect, a spatial aspect, an ordering, etc. Rather, such terms are merely used as identifiers, names, etc. for features, elements, items, etc., e.g., a first object and a second object generally correspond to object A and object B or two different or two identical objects or the same object.

Moreover, “example” and “e.g.,” is used herein to mean serving as an example, instance, illustration, etc., and not necessarily as advantageous. As used herein, “user” can be a content creator, a content publisher, or a visitor. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B or the like generally means A or B or both A and B. Furthermore, to the extent that “includes”, “having”, “has”, “with”, or variants thereof are used in either the detailed description or the claims, such terms are intended to be inclusive in a manner similar to the term “comprising”.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure.

What is claimed is:

1. A system for disputes comprising:
one or more communicatively coupled servers comprising one or more computer processors and one or more memory devices that store and process dispute information;
one or more user instances hosted by the one or more communicatively coupled servers, wherein each of the one or more user instances has a unique identifier and associated one or more characteristic values, including a set of trait data and a set of history data;
the unique identifier and the one or more characteristic values associated with the user instances are stored in the one or more memory devices communicatively coupled to the one or more communicatively coupled servers and the one or more computer processors;
one or more computer processors that adjust the characteristic values associated with each of the user instances to reflect changes in the characteristic values;
one or more computer processors that automatically receive dispute information in real time and automatically adjusts in real time the characteristic values of the unique identifier associated with each of the user instances based on the dispute information;
one or more dispute instances hosted by a server, wherein each of the one or more dispute instances is defined by dispute characteristics, including a duration, a topic, one or more characteristic values, and a difficulty level;
one or more computer processors that assigns a weight to the one or more characteristic values associated with the user instances, wherein the weight assigned to each of the one or more characteristic values associated with the one or more user instances is determined based on one or more of: collected points, number of wins and losses, total dispute time, and achieved difficulty level of the one or more user instances;
one or more computer processors comprise a selective forward unit server that combines user dispute streams of dispute instances;
the selective forward unit server feeds real-time user dispute streams associated with the unique identifier of the user instances to a virtual bot that facilitates the streaming and recording of the user dispute streams;
a server combines the user dispute streams into a dispute single stream, which is delivered to a real time messaging protocol server;
the real time messaging protocol server can deliver the dispute single stream to a storage system that can be accessed by users for playback; and
based on the weighted characteristic values and dispute characteristics, the one or more computer processors automatically combine users into one or more dispute instances where a user identified by a unique identifier participates in or views a dispute, wherein the one or more computer processors launch the dispute at a predetermined time.

2. The system for disputes as in claim 1, wherein FFmpeg commands are be used to capture and encode the user dispute data streams.

3. The system for disputes as in claim 1, wherein a user dispute data stream can be routed from the real time messaging protocol server to a server via an HLS protocol, allowing users to join and participate in a live dispute.

4. The system for disputes as in claim 1, wherein an instance of the dispute single stream can be remixed from FLV to MP4 format and delivered to the storage system.

5. The system for disputes as in claim 1, wherein a user can opt out of having their user dispute stream recorded.

6. The system for disputes as in claim 1, wherein the system charges a fee for the playback of a recorded dispute.

7. A system for disputes comprising:
one or more communicatively coupled servers comprising one or more communicatively coupled computer processors and one or more memory devices each having at least one database accessible by the one or more communicatively coupled computer processors;
one or more user instances hosted by a server, wherein each of the one or more user instances has a unique identifier and one or more characteristic values, comprising in-system and external data, stored in the one or more memory devices;
one or more dispute instances hosted by a selective forward unit server, wherein each of the one or more dispute instances is defined by dispute characteristics;
the one or more communicatively coupled computer processors configured to organize a social network by:
continuously tracking and collecting in-system and external data associated with the unique identifier of user instances in real time;
accessing and adjusting the characteristic values stored in the one or more memory devices in real time to reflect changes in characteristic values based on the in-system and external data collected;
assigning a weight to the one or more characteristic values associated with the user instances based on the dispute characteristics;
determining a ranking of user instances based on the dispute characteristics and the weighted characteristic values;
automatically combining users into one or more dispute instances where a user identified by a unique identifier participates in or views a dispute;
launching the dispute at a predetermined time; and
recording the dispute using a virtual bot that routes the user dispute streams to a streaming server that combines the user dispute streams into a single dispute stream and delivers the dispute stream to a storage system for playback.

8. The system for disputes as in claim 7, wherein the one or more computer processors automatically records each dispute and saves the recorded disputes on a server for future playback.

9. The system for disputes as in claim 7, wherein a user instance can initiate the playback of a recorded dispute.

10. The system for disputes as in claim 7, wherein one user instance can assign rights to the playback of a recorded dispute to another user instance.

11. The system for disputes as in claim 7, wherein a user can opt out of being recorded.

12. The system for disputes as in claim 7, wherein the system charges a fee for the playback of a recorded dispute.

13. A method for online disputing comprising:
enabling access to a central repository that shows disputes currently running or available to run on one or more computer processors as well as on a plurality of servers communicatively coupled to the one or more computer processors over communications links;
processing data for unique identifiers representative of one or more characteristic values including:
tracking and collecting data associated with the unique identifiers in real time;
processing the data associated with the unique identifiers;
automatically adjusting the characteristic values to reflect changes in the characteristic values based on data collected;
tracking dispute information associated with the unique identifiers in real time;
processing the dispute information associated with the unique identifiers; and
automatically adjusting the characteristic values of the unique identifiers based on the dispute information;
defining a dispute by dispute characteristics;
assigning a weight to one or more characteristic values;
automatically associating the unique identifiers with disputes available to access based on the weighted characteristic values of the unique identifier and the dispute characteristics;
automatically combining users into a dispute instance where a user identified by a unique identifier participates in or views a dispute;
launching the dispute with combined users at an agreed upon time;
automatically deploying additional servers as disputes multiply or reach a predetermined number of users based on one or more pre-emptive algorithms including how many dispute instances are running and anticipated user demand; and
recording the dispute for playback using a virtual bot that routes the user dispute streams to a streaming server that combines the user dispute streams into a single dispute stream and delivers the dispute stream to a storage system for playback.

14. The method for disputing as in claim 13, wherein the one or more computer processors automatically records each dispute and saves the recorded disputes on a server for future playback.

15. The method for disputing as in claim 13, wherein a user instance initiates the playback of a recorded dispute.

16. The method for disputing as in claim 13, wherein a user instance assigns rights to the playback of a recorded dispute to another user instance.

17. The method for disputing as in claim 13, wherein a user can opt out of being recorded.

18. The method for disputing as in claim 13, further comprising charging a user a fee for the playback of a recorded dispute.
